(19) United States
(12) Patent Application Publication
(10) Pub. No.: US 2026/0341973 A1
(43) Pub. Date: Oct. 29, 2026

(54) ANTENNAS AND ANTENNA ARRAYS

(71) Applicant: Honeywell International Inc., Charlotte, NC (US)

(72) Inventors: Daniel Joseph Richardson, Prague (CZ); Vojtech Bednarsky, Brno (CZ); Petr Vitek, Brno (CZ)

(21) Appl. No.: 19/186,820

(22) Filed: Apr. 23, 2025

(51) Int. Cl. H01Q 21/06; H01Q 3/26; H01Q 9/30; H01Q 9/42; H01Q 21/24

(52) U.S. Cl. CPC H01Q 21/061; H01Q 3/26; H01Q 9/30; H01Q 9/42; H01Q 21/24

(57) ABSTRACT

Antennas and antenna arrays are provided. For example, an antenna comprises a ground plane and first, second, third, and fourth conductive elements projecting through and upward from the ground plane. Each conductive element comprises a first segment projecting vertically upward from the ground plane; a second segment projecting from a distal end of the first segment at an upward angle relative to the ground plane; a third segment projecting from a distal end of the second segment at an upward angle and at a lateral angle from a longitudinal axis of the second segment; and a fourth segment projecting downward from a distal end of the third segment. Each conductive element is ninety degrees out of phase to each adjacent conductive element.

### TECHNOLOGICAL FIELD

Example embodiments of the present disclosure relate generally to antennas and, more particularly, to bent wire antennas.

### BACKGROUND

Antennas designed for L-band (1-2 gigahertz (GHz)) applications, particularly in the INMARSAT band (1518-1675 megahertz (MHz)), have strict requirements for circular polarization, wide angular coverage, and compact dimensions. Conventional planar antennas (e.g., patch antennas) often face limited bandwidth and reduced performance at lower elevation angles.

Applicant has discovered problems with current implementations of antennas designed for the INMARSAT band. Through applied effort, ingenuity, and innovation, many of these identified problems have been solved by developing solutions that are included in embodiments of the present disclosure, many examples of which are described in detail herein.

### BRIEF SUMMARY

In general, embodiments of the present disclosure provided herein provide improvements in antennas, antenna arrays, and associated methods for constructing antennas and antenna arrays and methods for transmitting and receiving radio frequency (RF) signals. Other implementations for antennas and antenna arrays will be, or will become, apparent to one with skill in the art upon examination of the following figures and detailed description. It is intended that all such additional implementations be included within this description be within the scope of the disclosure and be protected by the following claims.

In accordance with various embodiments of the present disclosure, an antenna is provided. In at least one example embodiment, an antenna comprises a ground plane and first, second, third, and fourth conductive elements projecting through and upward from the ground plane. Each conductive element comprises a first segment projecting vertically upward from the ground plane; a second segment projecting from a distal end of the first segment at an upward angle relative to the ground plane; a third segment projecting from a distal end of the second segment at an upward angle and at a lateral angle from a longitudinal axis of the second segment; and a fourth segment projecting downward from a distal end of the third segment. Each conductive element is ninety degrees out of phase to each adjacent conductive element.

In some embodiments, each conductive element has a diameter of 3.1-3.3 millimeters.

In some embodiments, each segment of each conductive element comprises at least a portion that is substantially straight.

In some embodiments, the ground plane is substantially square and each conductive element projects through the ground plane adjacent to a respective corner of the ground plane.

In some embodiments, the antenna further comprises fifth, sixth, seventh, and eighth conductive elements projecting through and upward from the ground plane. Each of the fifth, sixth, seventh, and eighth conductive elements comprise a first segment projecting vertically upward from the ground plane; a second segment projecting from a distal end of the first segment at an upward angle relative to the ground plane; a third segment projecting from a distal end of the second segment at an upward angle and at a lateral angle from a longitudinal axis of the second segment; and a fourth segment projecting downward from a distal end of the third segment. The fifth conductive element is positioned between the first conductive element and the second conductive element and is tuned to achieve 180 degrees out of phase from the first conductive element. The sixth conductive element is positioned between the second conductive element and the third conductive element and is tuned to achieve 180 degrees out of phase from the second conductive element. The seventh conductive element is positioned between the third conductive element and the fourth conductive element and is tuned to achieve 180 degrees out of phase from the third conductive element. The eighth conductive element is positioned between the fourth conductive element and the first conductive element and is tuned to achieve 180 degrees out of phase from the fourth conductive element. Each of the fifth, sixth, seventh, and eighth conductive elements is ninety degrees out of phase to each adjacent one of the fifth, sixth, seventh, and eighth conductive elements.

In some embodiments, the first, second, third, and fourth conductive elements are configured to transmit RF signals and the fifth, sixth, seventh, and eighth conductive elements are configured to receive RF signals.

In some embodiments, each conductive element further comprises a fifth segment projecting downward from a distal end of the fourth segment.

In some embodiments, the third segment of each conductive element is at a different angle relative to a respective edge of the ground plane than the third segment of each other conductive element.

In accordance with another aspect of the disclosure, an antenna is provided. In at least one example embodiment, an antenna comprises a ground plane, first, second, third, and fourth conductive transmitting elements, and first, second, third, and fourth conductive receiving elements projecting through and upward from the ground plane. Each conductive element comprises a first segment projecting vertically upward from the ground plane; a second segment projecting from a distal end of the first segment at an upward angle relative to the ground plane; a third segment projecting from a distal end of the second segment at an upward angle and at a lateral angle from a longitudinal axis of the second segment; a fourth segment projecting downward from a distal end of the third segment; and a fifth segment projecting downward from a distal end of the fourth segment. Each conductive transmitting element is ninety degrees out of phase to each adjacent conductive transmitting element. Each conductive receiving element is ninety degrees out of phase to each adjacent conductive receiving element. The first conductive transmitting element and the first conductive receiving element are 180 degrees out of phase to each other. The second conductive transmitting element and the second conductive receiving element are 180 degrees out of phase to each other. The third conductive transmitting element and the third conductive receiving element are 180 degrees out of phase to each other. The fourth conductive transmitting element and the fourth conductive receiving element are 180 degrees out of phase to each other.

In accordance with yet another aspect of the disclosure, an antenna array is provided. In at least one example embodiment, an antenna array comprises first, second, third, and fourth antennas. Each antenna comprises a ground plane and first, second, third, and fourth conductive elements projecting through and upward from the ground plane. Each conductive element comprises a first segment projecting vertically upward from the ground plane; a second segment projecting from a distal end of the first segment at an upward angle relative to the ground plane; a third segment projecting from a distal end of the second segment at an upward angle and at a lateral angle from a longitudinal axis of the second segment; and a fourth segment projecting downward from a distal end of the third segment. Each conductive element is ninety degrees out of phase to each adjacent conductive element.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 is a perspective view of an example antenna array, in accordance with some embodiments of the present disclosure;

FIG. 2 is a perspective view of the example antenna array of FIG. 1 with the radome removed, in accordance with some embodiments of the present disclosure;

FIG. 3 is a top view of the example antenna array of FIG. 2;

FIG. 4 is a close-up perspective view of an example conductive element of the example antenna array of FIG. 2;

FIGS. 5A-D are, respectively, side, perspective, top, and front views of an example conductive element of the example antenna array of FIG. 2;

FIG. 6 is a perspective view of an example antenna array with its radome removed, in accordance with some other embodiments of the present disclosure;

FIG. 7 is a top view of the example antenna array of FIG. 6;

FIG. 8 is a close-up perspective view of an example conductive element of the example antenna array of FIG. 6; and

FIGS. 9A-D are, respectively, side, perspective, top, and front views of an example conductive element of the example antenna array of FIG. 6.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, terms such as “front,” “rear,” “top,” “bottom,” “left,” “right,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The phrases “in one example,” “according to one example,” “in some examples,” and the like generally mean that the particular feature, structure, or characteristic following the phrase may be included in at least one example of the present disclosure and may be included in more than one example of the present disclosure (importantly, such phrases do not necessarily refer to the same example).

If the specification states a component or feature “may,” “can,” “could,” “should,” “would,” “preferably,” “possibly,” “typically,” “optionally,” “for example,” “as an example,” “in some examples,” “often,” or “might” (or other such language) be included or have a characteristic, that specific component or feature is not required to be included or to have the characteristic. Such component or feature may be optionally included in some examples, or it may be excluded.

The word “example” or “exemplary” is used herein to mean “serving as an example, instance, or illustration.” Any implementation described herein as “example” or “exemplary” is not necessarily to be construed as preferred or advantageous over other implementations.

The term “electronically coupled,” “electronically coupling,” “electronically couple,” “in communication with,” “in electronic communication with,” or “connected” in the present disclosure refers to two or more elements or components being connected through wired means and/or wireless means, such that signals, electrical voltage/current, data and/or information may be transmitted to and/or received from these elements or components.

The term “component” may refer to an article, a device, or an apparatus that may comprise one or more surfaces, portions, layers and/or elements. For example, an example component may comprise one or more substrates that may provide underlying layer(s) for the component and may comprise one or more elements that may form part of and/or are disposed on top of the substrate. In the present disclosure, the term “element” may refer to an article, a device, or an apparatus that may provide one or more functionalities.

Various embodiments of the present disclosure provide an innovative design of a monopole circular polarized antenna array targeting the INMARSAT band (1518–1675 MHz) within the L-band. Various embodiments employ multiple curved (also termed bent) conductors (also termed elements) arranged in a compact structure. In various embodiments, each of the bent elements is a monopole, which is a quarter-wavelength radiator fed at the ground plane. In various embodiments, each bent element is physically shortened compared to a standard monopole, with its effective electrical length increased by curvature, which reduces the resonant frequency. In various embodiments, each bent element is open-ended, unlike a dipole that has two arms. In various embodiments, each bent element is phase-controlled via dedicated ports (one port per wire within each element).

The careful arrangement of multiple bent elements of various embodiments of the present disclosure enable frequency tuning via the extended electrical length provided by the bent elements, circular polarization suitable for satellite communications, and beam steering through phased feeding, eliminating the need for mechanical rotation.

Various embodiments of the present disclosure provide multiple 4-element antennas arranged in an array (a 2 x 2 array is illustrated). Other embodiments of the present disclosure provide multiple 8-element antennas arranged in an array. Both the 4-element and the 8-element antenna arrays are illustrated herein as 2 x 2 arrays, however, any suitable number and arrangement of antennas can be used in an array.

In multi-element antennas (e.g., 4-wire or 8-wire), mutual coupling arises. In various embodiments, the geometry and spacing of the bent wires are designed to prevent significant amplitude or phase distortion among neighboring elements, thereby maintaining broadband performance and stable polarization. In various embodiments, the shape of the elements in each antenna of an array is identical, but they are rotated in relation to each other.

By phased feeding of each monopole element, the resulting radiation pattern (beam steering) of various embodiments can be adjusted from θ = 0 degrees up to 85 degrees, covering a full 360 degrees in the ϕ plane.

The antenna array of various embodiments can achieve high efficiency, broad angular coverage, and reduced antenna height. One specific example embodiment of the antenna array achieves an overall height of no more than two inches (including the ground plane), and approximately 26 millimeters (mm) for the radiating portion. This low-profile structure is well-suited for drones or other mobile platforms.

In various embodiments, each element of each antenna is fed by a separate port. In various embodiments, specific phase shifts (0°, -90°, +90°, -180°) applied to each port generate the desired circular polarization. To provide beam steering in the θ plane, various embodiments of the present disclosure employ multiple elements arranged in a grid (e.g., 2×2), feed each element through a dedicated splitter, and adjust inter-element phase to shift the main beam, covering θ from 0° to 85° and the entire ϕ range (360°).

In various embodiments of the 8-element antenna, four elements are tuned to the downlink band and four elements are tuned to the uplink band. That is, four elements receive (Rx) RF signals and four elements transmit (Tx) RF signals. With proper design, interference between these sets of conductors is reduced, offering reduced weight and size as compared to conventional multi-antenna solutions.

While embodiments of the present disclosure are described herein related to antennas and antenna arrays for the INMARSAT band (1518–1675 MHz) within the L-band, antennas and antenna arrays of embodiments of the present disclosure may be used for transmitting and receiving in any suitable frequency band(s).

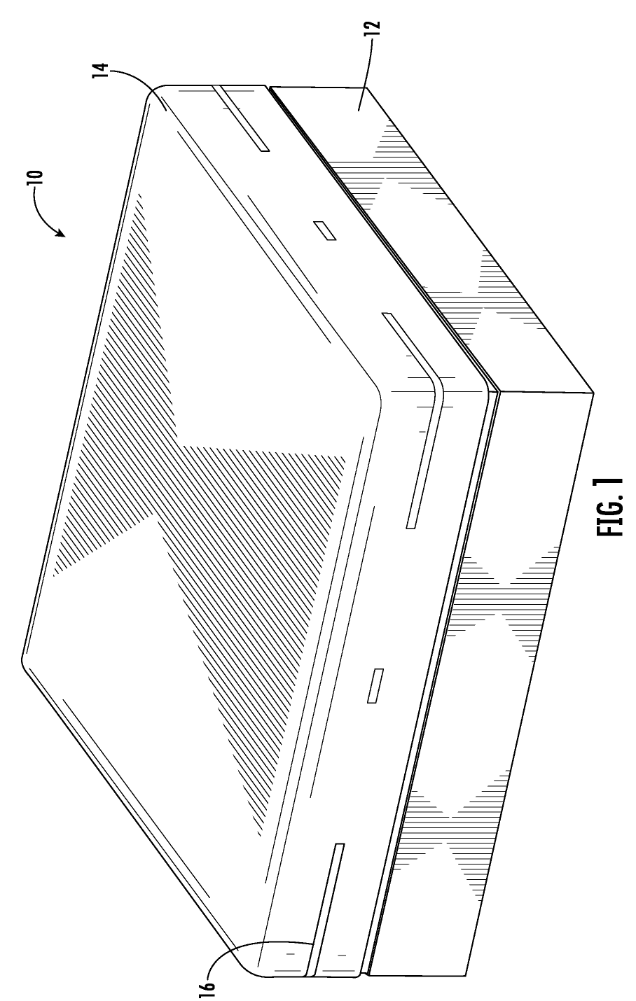

Referring now to the figures, FIGS. 1-5 illustrate an example antenna array in accordance with some embodiments of the present disclosure. As seen in FIG. 1, the antenna array 10 comprises a base 12 and a radome 14 attached thereto. The radome 14 forms an interior chamber to enclose the conductive elements of the individual antennas of the array to provide protection from the environment (e.g., rain, snow, etc.). The radome 14 is manufactured from a material that is substantially transparent to RF signals, such as any suitable plastic (e.g., polyethylene). In the illustrated embodiment, the radome 14 has a plurality of conductive strips 16 along its walls to improve radiation in certain directions. In various embodiments, the conductive strips 16 may be constructed of any suitable conductive material, such as copper.

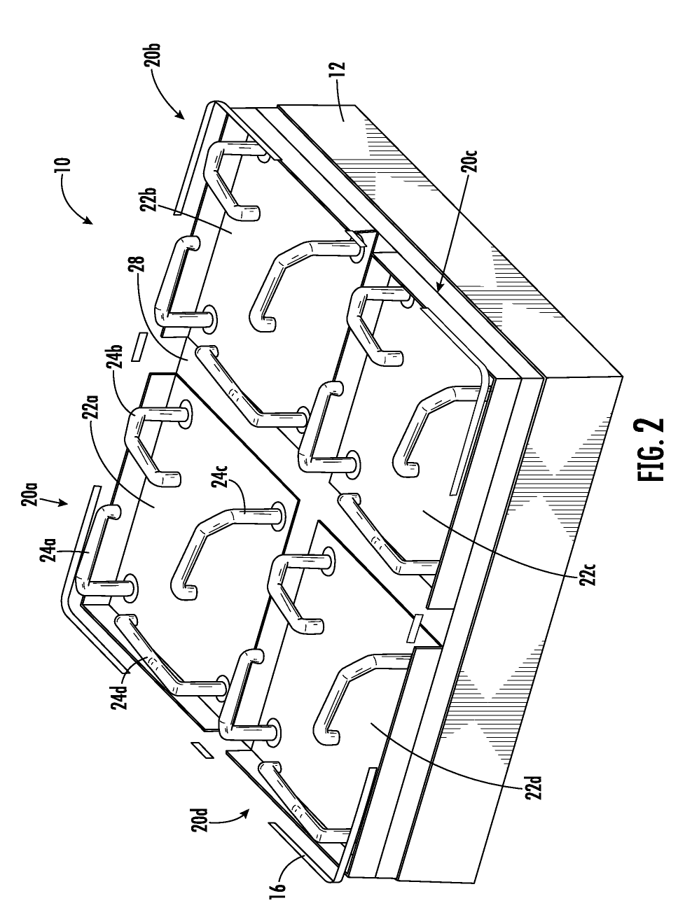

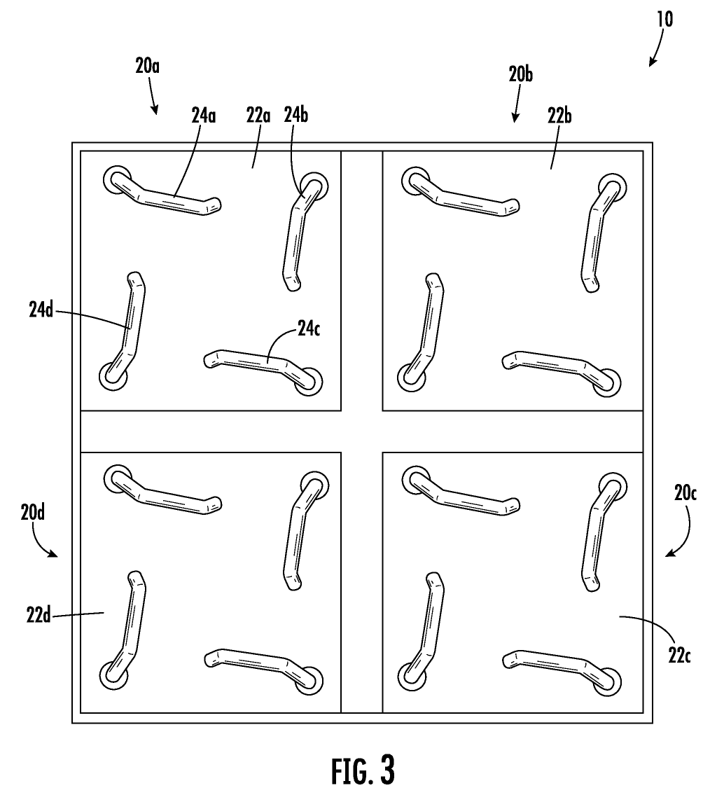

As seen in FIGS. 2 and 3 with the radome 14 removed for visibility, the antenna array 10 comprises four identical individual antennas—a first antenna 20a, a second antenna 20b, a third antenna 20c, and a fourth antenna 20d—arranged in a 2 x 2 array. Each of the four antennas of the array comprise a respective ground plane 22a, 22b, 22c, 22d. Each of the four antennas of the array comprise four bent elements projecting through and upward from the ground plane 22a, 22b, 22c, 22d (only the elements 24a, 24b, 24c, 24d of the first antenna 20a are labeled).

In the illustrated embodiment, a dielectric material 28 is positioned between each pair of adjacent antennas. Generally, there is a gap between each pair of adjacent antennas in an antenna array. In various embodiments, adding the dielectric material 28 allows the gap and therefore the array to be smaller.

The conductive strips 16 are illustrated in FIG. 2 (despite removal of the radome) so that the positioning of the conductive strips 16 can be seen better. In the illustrated embodiment, there is a long conductive strip that wraps around each corner of the radome and a short conductive strip in the center of each wall of the radome. In various embodiments, any suitable number, size, and placement of conductive strips may be used.

As seen in FIG. 2, the shape of each of the elements 24a, 24b, 24c, 24d in each antenna of an array is identical, but they are rotated in relation to each other (this is best seen in FIG. 3). In the illustrated embodiment, each of the elements 24a, 24b, 24c, 24d is 90 degrees out of phase to each adjacent element.

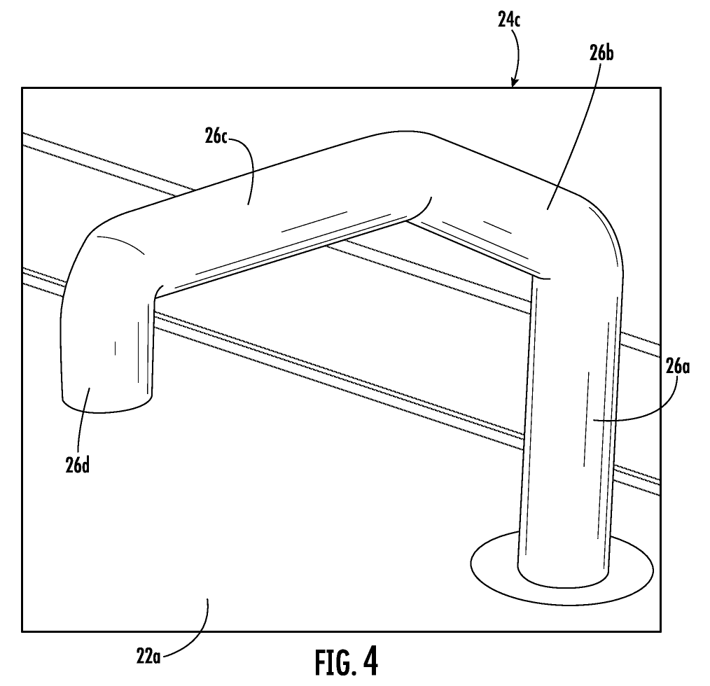

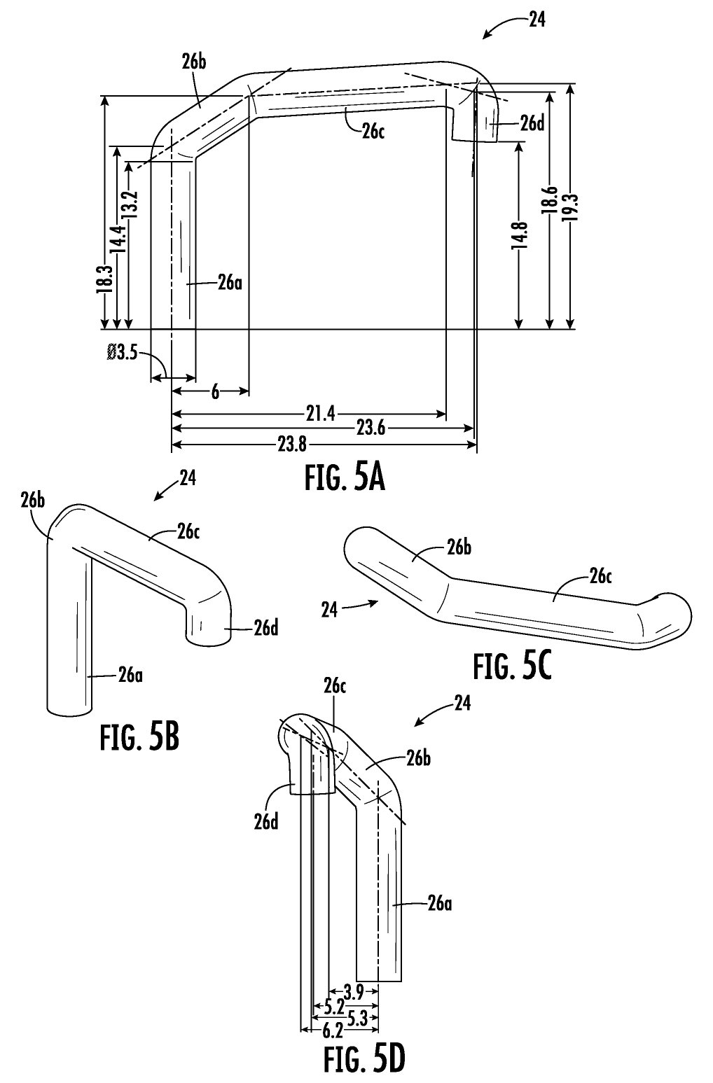

The shape of the conductive elements of the antenna array 10 is best seen in FIGS. 4 and 5A-D which illustrate conductive element 24c of the first antenna 20a. As seen in FIG. 4, the conductive element 24c comprises a first segment 26a projecting vertically upward from the ground plane 22a, a second segment 26b projecting from a distal end of the first segment 26a at an upward angle relative to the ground plane 22a, a third segment 26c projecting from a distal end of the second segment 26b at an upward angle and at a lateral angle from a longitudinal axis of the second segment 26b, and a fourth segment 26d projecting downward from a distal end of the third segment 26c. In the illustrated embodiment, a curved connecting portion joins each pair of adjacent segments.

FIGS. 5A-D illustrate dimensions (in mm) for one specific embodiment of the present disclosure. The lengths of each one of the segments 26a, 26b, 26c, 26d are selected to work at the desired INMARSAT frequency band. In various embodiments, changing the lengths of the segments would change the frequency range at which the antennas work.

In various embodiments, the conductive elements are constructed of any suitable material, such as copper coated steel. In various embodiments, the conductive elements have any suitable diameter. For example, the diameter of the conductive elements may be 3.1-3.3mm. In one specific embodiment, the elements each have a diameter of 3.2mm. As another example, the diameter of the conductive elements may be 3.4-3.6mm. In one specific embodiment, the elements each have a diameter of 3.5mm. In various embodiments, the diameter of the elements determines the bandwidth of the antenna, such that a larger diameter would enable a larger frequency band and a smaller diameter would enable a smaller frequency band.

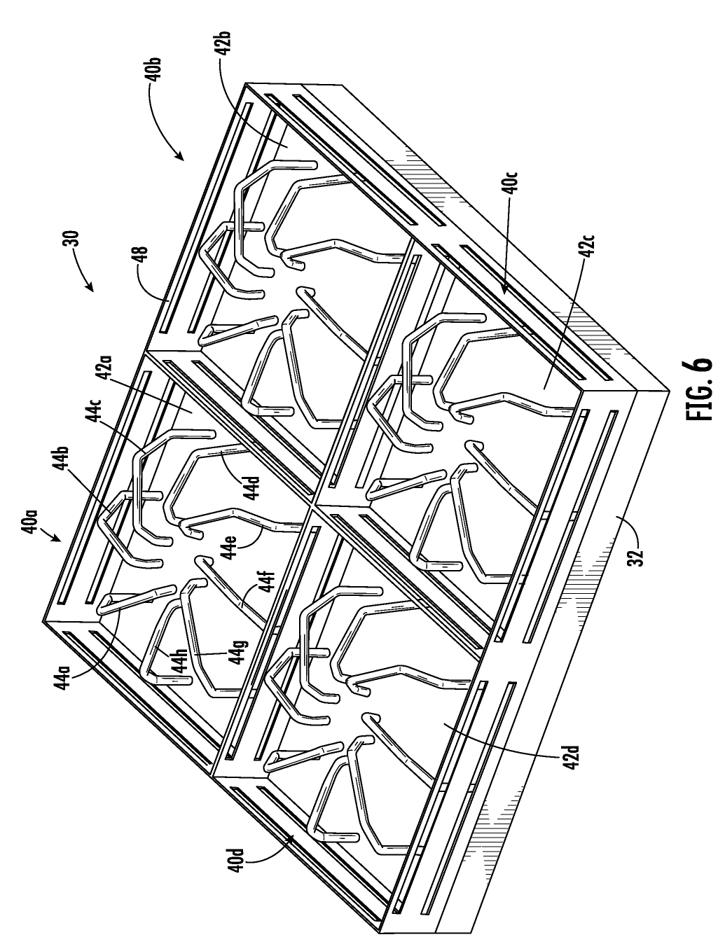

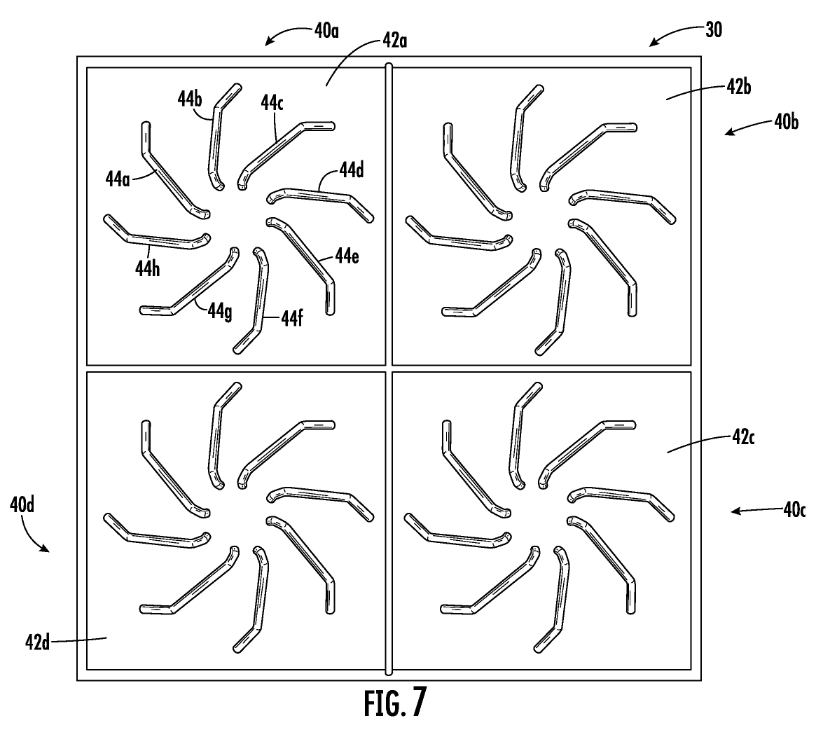

Referring now to FIGS. 6 and 7 which illustrate an example antenna array in accordance with some other embodiments of the present disclosure. The antenna array of FIGS. 6 and 7 is illustrated without its radome. As seen in FIG. 6, the antenna array 30 comprises four identical individual antennas—a first antenna 40a, a second antenna 40b, a third antenna 40c, and a fourth antenna 40d—arranged in a 2 x 2 array on a base 32.

Each of the four antennas 40a, 40b, 40c, 40d of the array 30 comprise a respective ground plane 42a, 42b, 42c, 42d. Each of the four antennas 40a, 40b, 40c, 40d of the array 30 comprise eight bent elements projecting through and upward from the ground plane 42a, 42b, 42c, 42d (only the elements 44a, 44b, 44c, 44d, 44e, 44f, 44g, 44h of the first antenna 40a are labeled).

In the illustrated embodiment of FIGS. 6 and 7, a wall 48 comprises an outer portion that surrounds the four antennas 40a, 40b, 40c, 40d and an inner portion between each pair of antennas in the antenna array 30. In some embodiments (not illustrated), the outer and inner walls differ in height to optimize reflections and reduce losses.

As described above, the use of eight conductive elements allows four elements to be used to receive RF signals and four elements to be used to transmit RF signals. This allow separate paths (circuitry) for Rx and Tx thus enabling improvements in isolation. For example, the Rx elements can be attached to a different printed circuit board (PCB) than the Tx elements. Then, for instance, each board can be separated by a metal shield. A secondary benefit of separate PCBs is the ability to control the phase to each set of elements (in this case, Rx elements and Tx elements). In the illustrated embodiment, the Tx elements are 44a, 44c, 44e, and 44g, while the Rx elements are 44b, 44d, 44f, and 44h.

As seen in FIG. 6, the shape of each of the elements 44a, 44b, 44c, 44d, 4e, 44f, 44g, 44h in each antenna of an array is identical, but they are rotated in relation to each other (this is best seen in FIG. 7). In the illustrated embodiment, each of the Tx elements 44a, 44c, 44e, 44g are 90 degrees out of phase to each adjacent Tx element, and each of the Rx elements 44b, 44d, 44f, 44h are 90 degrees out of phase to each adjacent Rx element. In various embodiments, the phase difference at the input between one Rx element (wire) and its respective Tx element (wire) differ by around 180 degrees at a specific Tx frequency, hence out of phase to each other and therefore resulting in destructive interference having the effect of wave cancelation at that particular frequency. For example, at the input to “Rx Element 1 frequency 1626.5 GHz” and at the input to “Tx Element 1 frequency 1626.5 GHz” the phase differs by roughly 180 degrees. So the Rx element is out of phase to the Tx element at this particular frequency point. This would be the same for all the other frequencies in the transmit band 1626.5 GHz to 1675 GHz as seen from the Rx element. This is accomplished by the control of the trace length on the PCB to each element, hence the Rx element would have the highest isolation from the Tx since the element, or in this case the bent wire, would have each Rx wire segment essentially out of phase to the transmit element. The same is done for Element 2 on Tx vs Element 2 on Rx and so on. As stated above, since in various embodiments there are independent paths on each PCB connected to the Rx elements or Tx elements, the phase difference between each subsequent Rx and Tx element can be optimized to achieve maximum isolation.

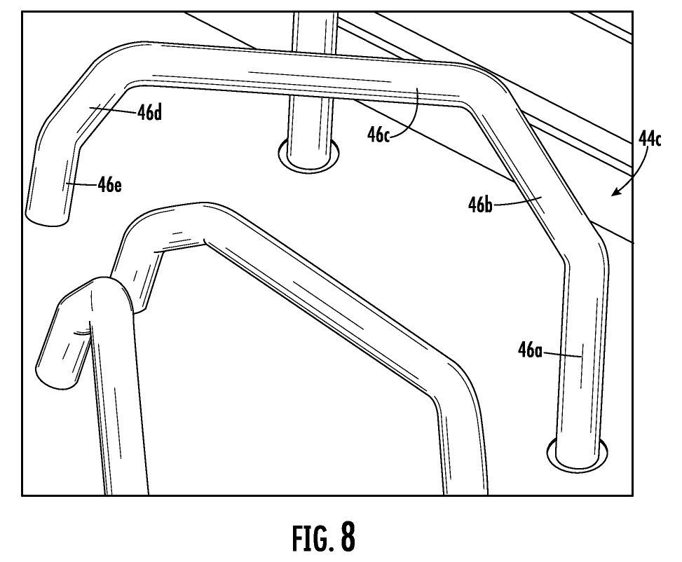

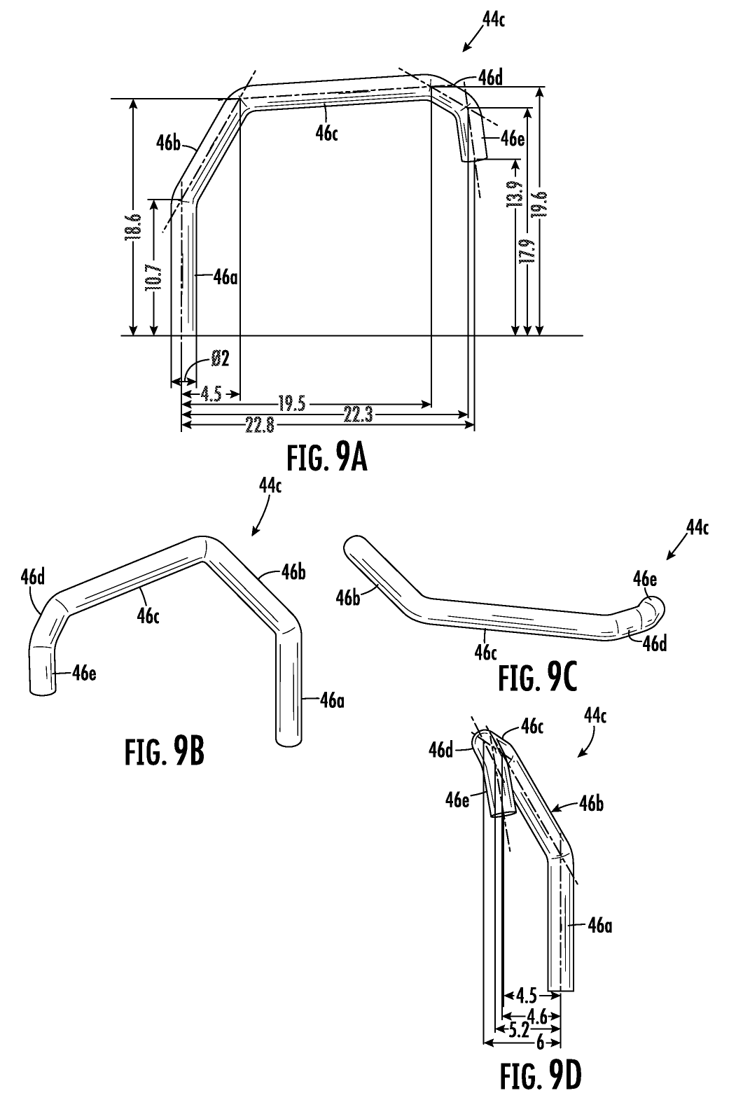

The shape of the conductive elements of the antennas 40a, 40b, 40c, 40d of the antenna array 30 is best seen in FIGS. 8 and 9A-D which illustrate conductive element 44c of the first antenna 40a. As seen in FIG. 8, the conductive element 44c comprises a first segment 46a projecting vertically upward from the ground plane 22a, a second segment 46b projecting from a distal end of the first segment 46a at an upward angle relative to the ground plane 42a, a third segment 46c projecting from a distal end of the second segment 46b at an upward angle and at a lateral angle from a longitudinal axis of the second segment 46b, a fourth segment 46d projecting downward from a distal end of the third segment 46c, and a fifth segment 46e projecting downward from a distal end of the fourth segment 46d. In the illustrated embodiment, a curved connecting portion joins each pair of adjacent segments.

FIGS. 9A-D illustrate dimensions (in mm) for one specific embodiment of the present disclosure. The lengths of each one of the segments 46a, 46b, 46c, 46d, 46e are selected to work at the desired INMARSAT frequency band. In various embodiments, changing the lengths of the segments would change the frequency range at which the antennas work. In various embodiments, the conductive elements have any suitable diameter. For example, the diameter of the conductive elements may be 1.9-2.1mm. In one specific embodiment, the elements each have a diameter of 2.0mm.

Various embodiments of the present disclosure provide an antenna array with improved omnidirectional coverage that maintains stable radiation patterns even at lower elevation angles.

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed.

What is claimed is:

1. An antenna comprising:
a ground plane; and
first, second, third, and fourth conductive elements projecting through and upward from the ground plane, each conductive element comprising:
a first segment projecting vertically upward from the ground plane;
a second segment projecting from a distal end of the first segment at an upward angle relative to the ground plane;
a third segment projecting from a distal end of the second segment at an upward angle and at a lateral angle from a longitudinal axis of the second segment; and
a fourth segment projecting downward from a distal end of the third segment;
wherein each conductive element is ninety degrees out of phase to each adjacent conductive element.

2. The antenna of claim 1, wherein each conductive element has a diameter of 3.1-3.3 millimeters.

3. The antenna of claim 1, wherein each segment of each conductive element comprises at least a portion that is substantially straight.

4. The antenna of claim 1, wherein the ground plane is substantially square; and
wherein each conductive element projects through the ground plane adjacent to a respective corner of the ground plane.

5. The antenna of claim 1, further comprising fifth, sixth, seventh, and eighth conductive elements projecting through and upward from the ground plane:
wherein each of the fifth, sixth, seventh, and eighth conductive elements comprise:
a first segment projecting vertically upward from the ground plane;
a second segment projecting from a distal end of the first segment at an upward angle relative to the ground plane;
a third segment projecting from a distal end of the second segment at an upward angle and at a lateral angle from a longitudinal axis of the second segment; and
a fourth segment projecting downward from a distal end of the third segment;
wherein the fifth conductive element is positioned between the first conductive element and the second conductive element and is tuned to achieve 180 degrees out of phase from the first conductive element;
wherein the sixth conductive element is positioned between the second conductive element and the third conductive element and is tuned to achieve 180 degrees out of phase from the second conductive element;
wherein the seventh conductive element is positioned between the third conductive element and the fourth conductive element and is tuned to achieve 180 degrees out of phase from the third conductive element;
wherein the eighth conductive element is positioned between the fourth conductive element and the first conductive element and is tuned to achieve 180 degrees out of phase from the fourth conductive element; and
wherein each of the fifth, sixth, seventh, and eighth conductive elements is ninety degrees out of phase to each adjacent one of the fifth, sixth, seventh, and eighth conductive elements.

6. The antenna of claim 5, wherein the first, second, third, and fourth conductive elements are configured to transmit radio frequency (RF) signals; and
wherein the fifth, sixth, seventh, and eighth conductive elements are configured to receive RF signals.

7. The antenna of claim 5, wherein each conductive element further comprises a fifth segment projecting downward from a distal end of the fourth segment.

8. The antenna of claim 1, wherein the third segment of each conductive element is at a different angle relative to a respective edge of the ground plane than the third segment of each other conductive element.

9. An antenna comprising:
a ground plane;
first, second, third, and fourth conductive transmitting elements; and
first, second, third, and fourth conductive receiving elements projecting through and upward from the ground plane;
wherein each conductive element comprises:
a first segment projecting vertically upward from the ground plane;
a second segment projecting from a distal end of the first segment at an upward angle relative to the ground plane;
a third segment projecting from a distal end of the second segment at an upward angle and at a lateral angle from a longitudinal axis of the second segment;
a fourth segment projecting downward from a distal end of the third segment; and
a fifth segment projecting downward from a distal end of the fourth segment
wherein each conductive transmitting element is ninety degrees out of phase to each adjacent conductive transmitting element;
wherein each conductive receiving element is ninety degrees out of phase to each adjacent conductive receiving element;
wherein the first conductive transmitting element and the first conductive receiving element are 180 degrees out of phase to each other;
wherein the second conductive transmitting element and the second conductive receiving element are 180 degrees out of phase to each other;
wherein the third conductive transmitting element and the third conductive receiving element are 180 degrees out of phase to each other; and
wherein the fourth conductive transmitting element and the fourth conductive receiving element are 180 degrees out of phase to each other.

10. The antenna of claim 9, wherein each conductive element has a diameter of 3.1-3.3 millimeters.

11. The antenna of claim 9, wherein each segment of each conductive element comprises at least a portion that is substantially straight.

12. The antenna of claim 9, wherein the ground plane is substantially square; and
wherein each conductive transmitting element projects through the ground plane adjacent to a respective corner of the ground plane.

13. An antenna array comprising:
first, second, third, and fourth antennas, each antenna comprising:
a ground plane; and
first, second, third, and fourth conductive elements projecting through and upward from the ground plane, each conductive element comprising:
a first segment projecting vertically upward from the ground plane;
a second segment projecting from a distal end of the first segment at an upward angle relative to the ground plane;
a third segment projecting from a distal end of the second segment at an upward angle and at a lateral angle from a longitudinal axis of the second segment; and
a fourth segment projecting downward from a distal end of the third segment;
wherein each conductive element is ninety degrees out of phase to each adjacent conductive element.

14. The antenna array of claim 13, wherein each conductive element of each antenna has a diameter of 3.1-3.3 millimeters.

15. The antenna array of claim 13, wherein each segment of each conductive element of each antenna comprises at least a portion that is substantially straight.

16. The antenna array of claim 13, wherein the ground plane of each antenna is substantially square; and
wherein each conductive element of each antenna projects through the ground plane of its respective antenna adjacent to a respective corner of its respective ground plane.

17. The antenna array of claim 13, wherein each antenna further comprises fifth, sixth, seventh, and eighth conductive elements projecting through and upward from the ground plane of each respective antenna:
wherein each of the fifth, sixth, seventh, and eighth conductive elements of each antenna comprise:
a first segment projecting vertically upward from the ground plane;
a second segment projecting from a distal end of the first segment at an upward angle relative to the ground plane;
a third segment projecting from a distal end of the second segment at an upward angle and at a lateral angle from a longitudinal axis of the second segment;
a fourth segment projecting downward from a distal end of the third segment; and
a fifth segment projecting downward from a distal end of the fourth segment;
wherein the fifth conductive element of each antenna is positioned between the first conductive element and the second conductive element of the respective antenna and is tuned to achieve 180 degrees out of phase from the first conductive element of the respective antenna;
wherein the sixth conductive element of each antenna is positioned between the second conductive element and the third conductive element of the respective antenna and is tuned to achieve 180 degrees out of phase from the second conductive element of the respective antenna;
wherein the seventh conductive element of each antenna is positioned between the third conductive element and the fourth conductive element of the respective antenna and is tuned to achieve 180 degrees out of phase from the third conductive element of the respective antenna;
wherein the eighth conductive element of each antenna is positioned between the fourth conductive element and the first conductive element of the respective antenna and is tuned to achieve 180 degrees out of phase from the fourth conductive element of the respective antenna; and
wherein each of the fifth, sixth, seventh, and eighth conductive elements of each antenna is ninety degrees out of phase to each adjacent one of the fifth, sixth, seventh, and eighth conductive elements of the respective antenna.

18. The antenna array of claim 17, wherein the first, second, third, and fourth conductive elements of each antenna are configured to transmit radio frequency (RF) signals; and
wherein the fifth, sixth, seventh, and eighth conductive elements of each antenna are configured to receive RF signals.

19. The antenna array of claim 17, wherein each conductive element of each antenna further comprises a fifth segment projecting downward from a distal end of the respective fourth segment.

20. The antenna array of claim 13, further comprising dielectric material positioned between each pair of adjacent antennas.
